(19) United States
(12) Patent Application Publication
(10) Pub. No.: US 2017/0147427 A1
(43) Pub. Date: May 25, 2017

(54) SYSTEM AND METHOD FOR SOFTWARE SIMULATION FOR TESTING A SAFETY MANAGER PLATFORM

(71) Applicant: Honeywell International, Inc., Morris Plains, NJ (US)

(72) Inventor: Richard Nero, Richmond, TX (US)

(21) Appl. No.: 14/949,619

(22) Filed: Nov. 23, 2015

(51) Int. Cl. G06F 11/07; G06F 11/22

(52) U.S. Cl. CPC G06F 11/0796; G06F 11/221; G06F 11/0745; G06F 2201/875

(57) ABSTRACT

A method includes transmitting an output file to a safety manager, where the output file is based on a configuration file associated with a plurality of inputs and outputs of the safety manager. The method also includes, for each input/output (I/O) channel of the safety manager to be tested, (i) displaying information associated with an expected state of the I/O channel, (ii) instructing the safety manager to simulate a particular operating condition in association with the I/O channel, (iii) receiving a response from the safety manager when the I/O channel is shorted, where the response indicates whether or not the I/O channel is operating correctly, and (iv) displaying the response.

### TECHNICAL FIELD

This disclosure relates generally to industrial process control and automation systems. More specifically, this disclosure relates to a system and method for software simulation for testing a safety manager platform.

### BACKGROUND

Industrial process control and automation systems, including direct current (DC) powered control systems, are often used to automate large and complex industrial processes. These types of systems routinely include sensors, actuators, and controllers. The controllers typically receive measurements from the sensors and generate control signals for the actuators.

In some industrial facilities, a safety manager platform can operate in parallel with the industrial process control and automation system and provide a layer of safety beyond the safety controls within the process control and automation system itself. For example, certain elements of a process control and automation system (such as a pressure valve) can fail, which can cause a system failure. A safety manager platform may have additional sensors or other devices to detect such a failure or detect conditions leading up to a failure. Upon detection of a current or imminent failure, the safety manager can shut down one or more processes in the system to a safe state.

### SUMMARY

This disclosure provides a system and method for software simulation for testing a safety manager platform.

In a first embodiment, a method includes transmitting an output file to a safety manager, where the output file is based on a configuration file associated with a plurality of inputs and outputs of the safety manager. The method also includes, for each input/output (I/O) channel of the safety manager to be tested, (i) displaying information associated with an expected state of the I/O channel, (ii) instructing the safety manager to simulate a particular operating condition in association with the I/O channel, (iii) receiving a response from the safety manager when the I/O channel is shorted, where the response indicates whether or not the I/O channel is operating correctly, and (iv) displaying the response.

In a second embodiment, an apparatus includes at least one processing device and at least one interface configured to communicate with a safety manager. The at least one processing device is configured to initiate transmission of an output file to the safety manager, where the output file is based on a configuration file associated with a plurality of inputs and outputs of the safety manager. The at least one processing device is also configured, for each I/O channel of the safety manager to be tested, to (i) display information associated with an expected state of the I/O channel, (ii) instruct the safety manager to simulate a particular operating condition in association with the I/O channel, (iii) receive a response from the safety manager when the I/O channel is shorted, where the response indicates whether or not the I/O channel is operating correctly, and (iv) display the response.

In a third embodiment, a non-transitory computer readable medium contains instructions that, when executed by at least one processing device, cause the at least one processing device to initiate transmission of an output file to a safety manager, where the output file is based on a configuration file associated with a plurality of inputs and outputs of the safety manager. The medium also contains instructions that, when executed by at least one processing device, cause the at least one processing device, for I/O channel of the safety manager to be tested, to (i) display information associated with an expected state of the I/O channel, (ii) instruct the safety manager to simulate a particular operating condition in association with the I/O channel, (iii) receive a response from the safety manager when the I/O channel is shorted, where the response indicates whether or not the I/O channel is operating correctly, and (iv) display the response.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates example portions of a safety manager system for use with an industrial process control and automation system according to this disclosure;

FIG. 3 illustrates an example test system for testing safety manager components according to this disclosure;

FIG. 4 illustrates an example of a graphical user interface (GUI) for use with the test system of FIG. 3 according to this disclosure;

FIG. 5 illustrates example portions of a configuration file that is formatted as a Cause and Effect (C&E) chart according to this disclosure;

FIG. 6 illustrates an example method for testing a safety manager according to this disclosure; and

FIG. 7 illustrates an example computing device for implementing the methods and teachings according to this disclosure.

### DETAILED DESCRIPTION

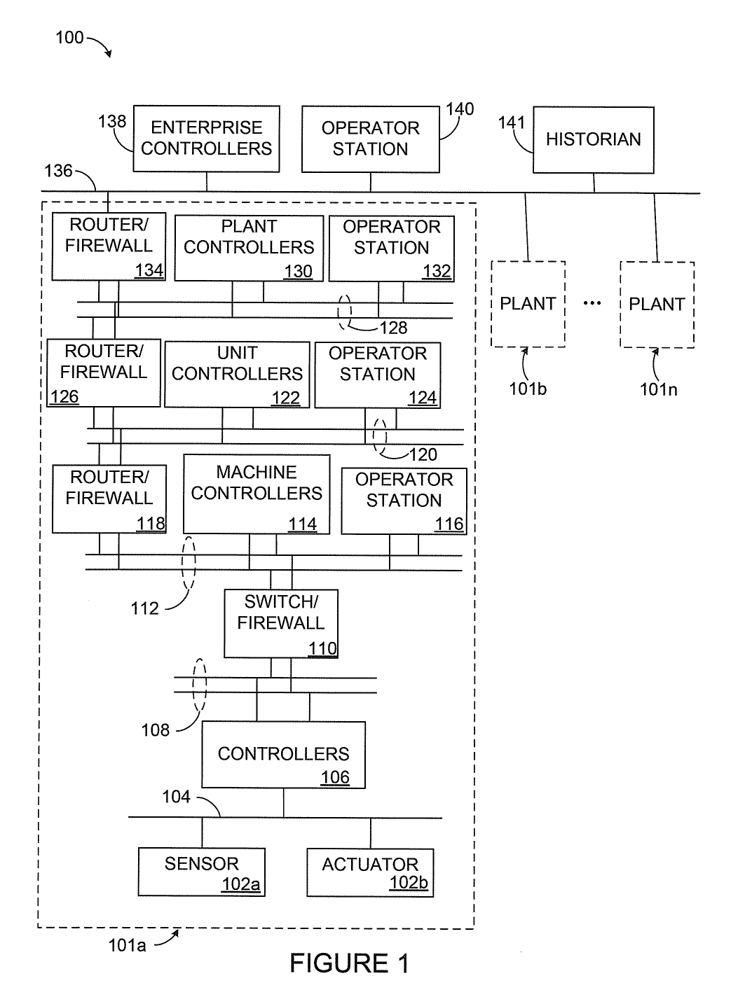

FIGS. 1 through 7, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Multiple controllers 106 could also operate in redundant configurations, such as when one controller 106 operates as a primary controller while another controller 106 operates as a backup controller (which synchronizes with the primary controller and can take over for the primary controller in the event of a fault with the primary controller). Each controller 106 includes any suitable structure for interacting with one or more sensors 102a and controlling one or more actuators 102b. Each controller 106 could, for example, represent a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers and operator stations could include one or more processing devices and one or more memories for storing instructions and data used, generated, or collected by the processing device(s). Each of the controllers and operator stations could also include at least one network interface, such as one or more Ethernet interfaces or wireless transceivers.

One or more of the controllers in the system 100 (such as the plant controllers 130 or enterprise controllers 138) could implement at least one safety manager system. The safety manager system generally operates to promote or manage safe operation of the system 100. As a particular example, one or more of the controllers in the system 100 could represent or implement a safety manager for use in the safety manager system. In accordance with this disclosure, each safety manager can be tested to ensure proper operation of the safety manager and the safety manager system. Additional details regarding this functionality are provided below.

Although FIG. 1 illustrates one example of an industrial process control and automation system 100, various changes may be made to FIG. 1. For example, a control system could include any number of sensors, actuators, controllers, servers, operator stations, networks, and safety managers. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, process control systems are highly configurable and can be configured in any suitable manner according to particular needs. In addition, while FIG. 1 illustrates one example environment in which a safety manager system can be implemented, this functionality can be used in any other suitable device or system.

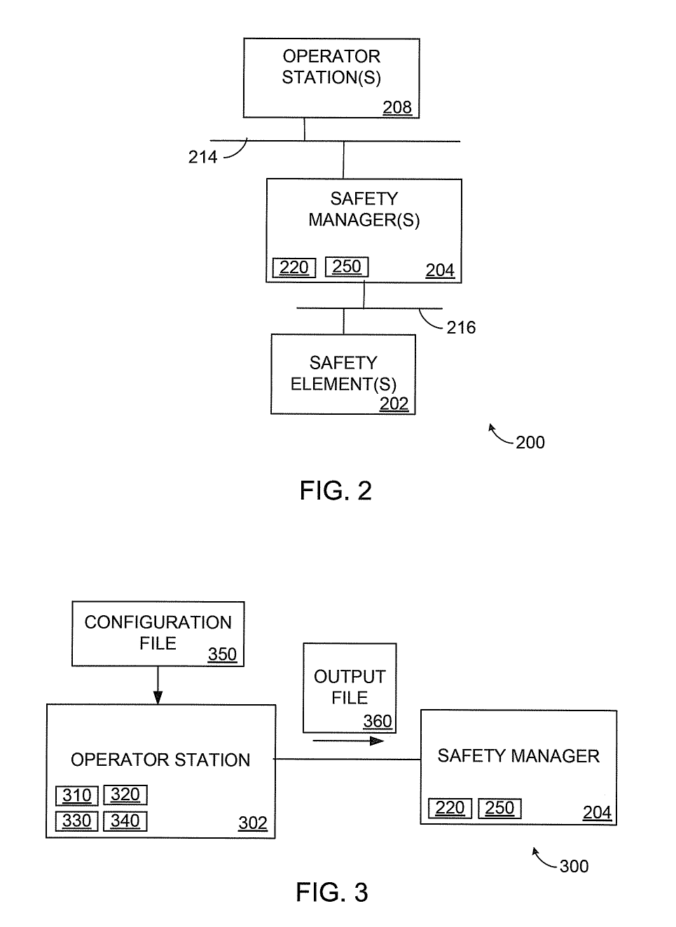

FIG. 2 illustrates example portions of a safety manager system 200 for use with an industrial process control and automation system according to this disclosure. The safety manager system 200 may be used in conjunction with the industrial process control and automation system 100 of FIG. 1. In particular embodiments, the safety manager system 200 could represent a safety manager system that helps to ensure safe operating conditions in the industrial process control and automation system 100. However, the safety manager system 200 could be used in or with any other suitable manner.

The safety manager system 200 can operate as part of or in parallel with the industrial process control and automation system 100 and can provide a layer of safety beyond safety controls within the process control and automation system 100 itself. As shown in FIG. 2, the safety manager system 200 includes one or more safety elements 202. The safety elements 202 represent components, such as sensors and actuators, that may be used in a process or production system to perform any of a wide variety of functions. For example, the safety elements 202 can represent one or more sensors, actuators, valves, and the like that operate in parallel with one or more sensors, actuators, valves, and the like of the process control and automation system 100. Each of the safety elements 202 includes any suitable structure for performing one or more functions in a process or production system.

At least one safety manager 204 is coupled to the safety elements 202. The safety manager 204 controls and manages the operation of the safety elements 202. For example, the safety manager 204 could receive measurements from sensors and generate control signals for actuators. Each safety manager 204 includes any suitable structure for controlling one or more of the safety elements 202. In some embodiments, the safety manager 204 may represent a SAFETY MANAGER HPS product from HONEYWELL INTERNATIONAL INC.

In some embodiments, the safety manager 204 includes one or more processing devices, such as one or more microprocessors, microcontrollers, digital signals processors, field programmable gate arrays, application specific integrated circuits, or discrete logic devices. The safety manager 204 also includes one or more memories storing instructions and data used, collected, or generated by the processing device(s), such as a random access memory or a Flash or other read-only memory. One or more interfaces 220 allow for communication between the safety manager 204 and other devices, such as a testing system as described in greater detail below. The one or more interfaces 220 can include any suitable communication interfaces, such as at least one serial port, Ethernet port, or both. In addition, the safety manager 204 includes a plurality of I/O points 250 facilitating communication with the safety elements 202. In particular embodiments, the I/O points 250 can include analog inputs, analog outputs, digital inputs, digital outputs, or a combination thereof.

At least one operator station 208 represents a computing or communication device providing user access to the safety manager 204 and the safety elements 202. As a particular example, the operator station 208 could allow users to review the operational history of the safety elements 202 using information collected by the safety manager 204. The operator station 208 could also allow the users to adjust the operation of the safety elements 202 and the safety manager 204. Each operator station 208 includes any suitable structure for supporting user access and control of the system 200, such as one or more processors, one or more memories, and one or more communication interfaces. Each operator station 208 could, for example, represent a computing device running a MICROSOFT WINDOWS operating system.

As shown in FIG. 2, the safety manager system 200 includes various networks 214-216 that support communication between components in the system 200. Each of these networks 214-216 represents any network or combination of networks facilitating communication between components in the system 200. The networks 214-216 could, for example, represent Ethernet networks.

Although FIG. 2 illustrates examples of portions of a safety manager system 200, various changes may be made to FIG. 2. For example, a safety manager system could include any number of controlled devices, controllers, and operator stations. Also, the makeup and arrangement of the system 200 is for illustration only. Components could be added, omitted, combined, or placed in any other configuration according to particular needs.

Before being placed into actual operation in a production environment, safety managers (such as the safety manager 204) are typically tested to ensure correct and accurate performance. For example, when testing a safety manager in a test environment, one or more codes or standards bodies typically require that all hardware and software of the safety manager be demonstrated to provide 100% correct functionality before being used to control a live process. A safety manager can include hundreds of I/O points, including analog inputs (AI), analog outputs (AO), digital inputs (DI), and digital outputs (DO) that connect to various safety elements (also referred to as field instruments), such as transmitters with 4-20 mA signals, 24 VDC powered switches, and 24 VDC powered valve solenoids. A single safety manager can transmit and receive hundreds of associated signals that are manipulated by a safety manager application to perform predefined actions (such as turning on and turning off field equipment). A single safety manager system (such as the safety manager system 200) can have multiple safety managers, resulting in thousands of I/O signals that need to be tested and proven to function correctly.

In some conventional testing environments, a hardwired test panel is used to test each safety manager. In general, a hardwired test panel includes a box with multiple dials or potentiometers (for analog inputs) and multiple switches (for digital inputs) that are used to test a safety manager. The test panel is connected to the safety manager, and every channel (such as every AI, AO, DI, and DO of the safety manager) requires a connection of one or multiple wires. In some systems, this can require the physical connection of thousands of wires. A hardware test is then performed that tests every analog and digital input. For example, the potentiometers of the test panel can transmit 4-20 mA signals into every AI of the safety manager, the switch contacts of the test panel can provide open and closed contacts for each DI, and 24 VDC LEDs (or other lamps) of the test panel can read each DO of the safety manager. A logic test can also be performed that tests the logic inside the safety manager.

Conventional test panels require substantial maintenance, require extensive time to physically wire up, and are available in limited supply, which can create issues on large projects. In addition, test panels can be unreliable and require continued troubleshooting during testing to prove that failed tests are not simply due to a malfunctioning test panel. Thus, a solution is desired that would eliminate the need for test panels, reduce the required time for set-up, and be flexible and scalable so that large projects could be tested as easily as small projects with minimal I/O channels.

To address these issues, this disclosure provides test systems and methods for quickly and effectively testing the I/O hardware and application software of a safety manager system. The disclosed embodiments allow physical testing of every I/O channel (such as every AI, AO, DI, DO, and the like) connected to the safety manager. The disclosed embodiments also provide the ability to transmit and receive signals to facilitate application logic tests and read subsequent output status to provide full hardware and software testing while meeting all required codes and standards. The disclosed embodiments provide a computer-based mechanism for I/O manipulation and status feedback and display. The computer-based mechanism makes use of standard office tools, such as MICROSOFT EXCEL, to tabulate test and logic result read-backs. Such features may be used in conjunction with a wide variety of safety manager systems, including the safety manager system 200. However, this disclosure is not limited to safety manager systems, and the principles disclosed here are applicable to other environments and industries.

FIG. 3 illustrates an example test system 300 for testing safety manager components according to this disclosure. The test system 300 may be used for testing components of the safety manager system 200 of FIG. 2. However, the test system 300 could be used in any other suitable manner or for testing any other suitable system.

As shown in FIG. 3, the test system 300 includes an operator station 302 coupled to the safety manager 204. The operator station 302 represents a computing device providing user access to, and a test environment for, the safety manager 204. The operator station 302 includes any suitable structure for supporting user access and testing of the safety manager 204. For example, the operator station 302 could include one or more processing devices, such as one or more microprocessors, microcontrollers, digital signals processors, field programmable gate arrays, application specific integrated circuits, or discrete logic devices. The operator station 302 also includes one or more memories for storing instructions and data used, collected, or generated by the processing device(s), such as a random access memory or a Flash or other read-only memory. In particular embodiments, the operator station 302 is a standard computer (such as a PC, laptop, tablet computer, and the like) running a MICROSOFT WINDOWS or other operating system.

In addition, the operator station 302 includes one or more interfaces 320 facilitating communication with the safety manager 204. In particular embodiments, the one or more interfaces 320 can include at least one serial port, Ethernet port, or both, for connecting to a corresponding interface (or interfaces) 220 of the safety manager 204. The operator station 302 is configured to read data from and write data to the safety manager 204 via at least one connection between the interface 320 and the corresponding interface 220 at the safety manager 204. In some embodiments, the system 300 and the communications between the operator station 302 and the safety manager 204 are confined within a local domain in order to maintain security.

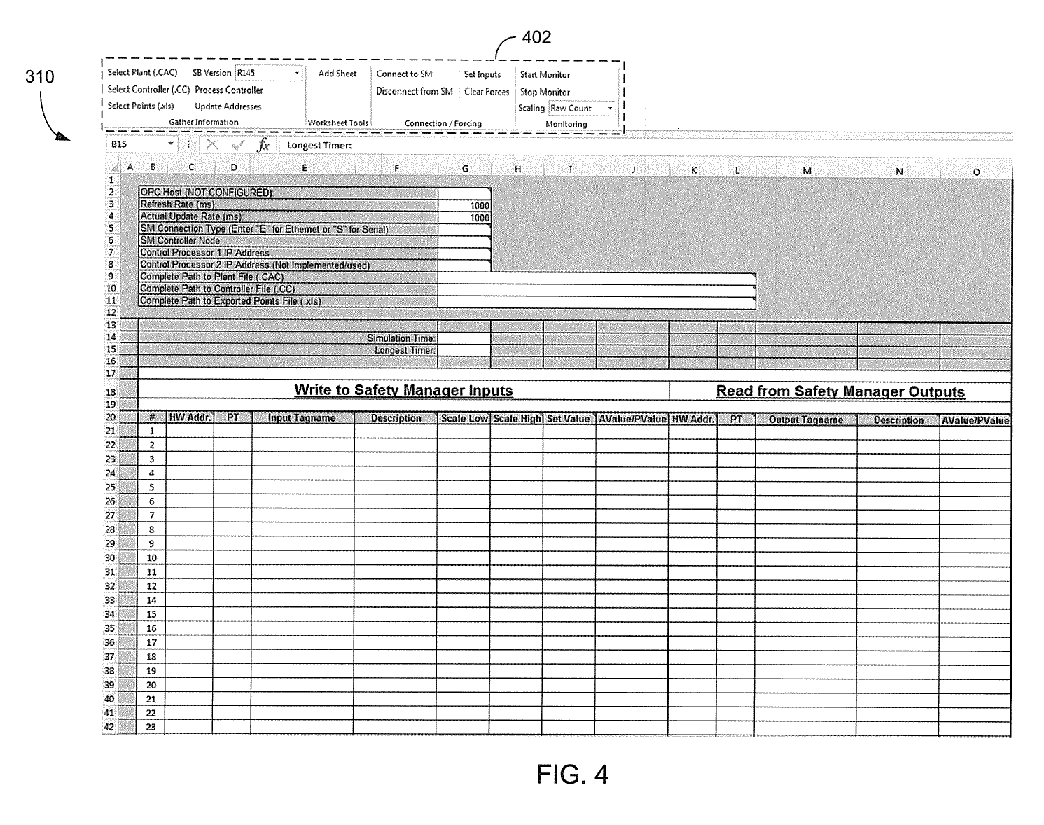

The operator station 302 also includes a graphical user interface (GUI) 310 that allows a user to exchange information with the test system 300. For example, the GUI 310 may allow a user to directly send instructions to the safety manager 204 and read status information regarding the programmed I/O channels associated with the I/O points 250 of the safety manager 204 without the need for wired connections to potentiometers, switches, and LED test panels. FIG. 4 illustrates one example of the GUI 310 for the test system 300 according to this disclosure. As shown in FIG. 4, the GUI 310 includes a control bar 402. In some embodiments, the control bar 402 may be a MICROSOFT OFFICE ribbon control. The control bar 402 includes a number of controls and functions that can be performed using the test system 300.

In some embodiments, testing functions of the test system 300 are provided using a plug-in tool 330 for MICROSOFT EXCEL. The plug-in tool 330 can be installed on the operator station 302. In particular embodiments, libraries and source code for the plug-in tool 330 can be developed around the .NET framework using the C# programming language. Of course, this is merely one example. In other embodiments, the plug-in tool 330 could be developed in other languages around other frameworks, which may be available in conjunction with other safety manager platforms.

In one aspect of operation, the operator station 302 is connected to the safety manager 204, and MICROSOFT EXCEL and the plug-in tool (or simply “tool”) 330 are launched on the operator station 302. The tool 330 is configured to operate within the parameters of MICROSOFT EXCEL to generate an EXCEL worksheet 340. For example, the tool 330 may receive or have access to a configuration file 350. In some embodiments, the tool 330 may prompt a user to provide the configuration file 350. For example, the user can specify a file location of the configuration file 350, provide the configuration file 350 in another format (such as a flash drive), or cut and paste the configuration file 350 as an input directly into the tool 330. In other embodiments, the tool 330 may automatically access the configuration file 350 based on a predetermined location where the configuration file 350 is stored.

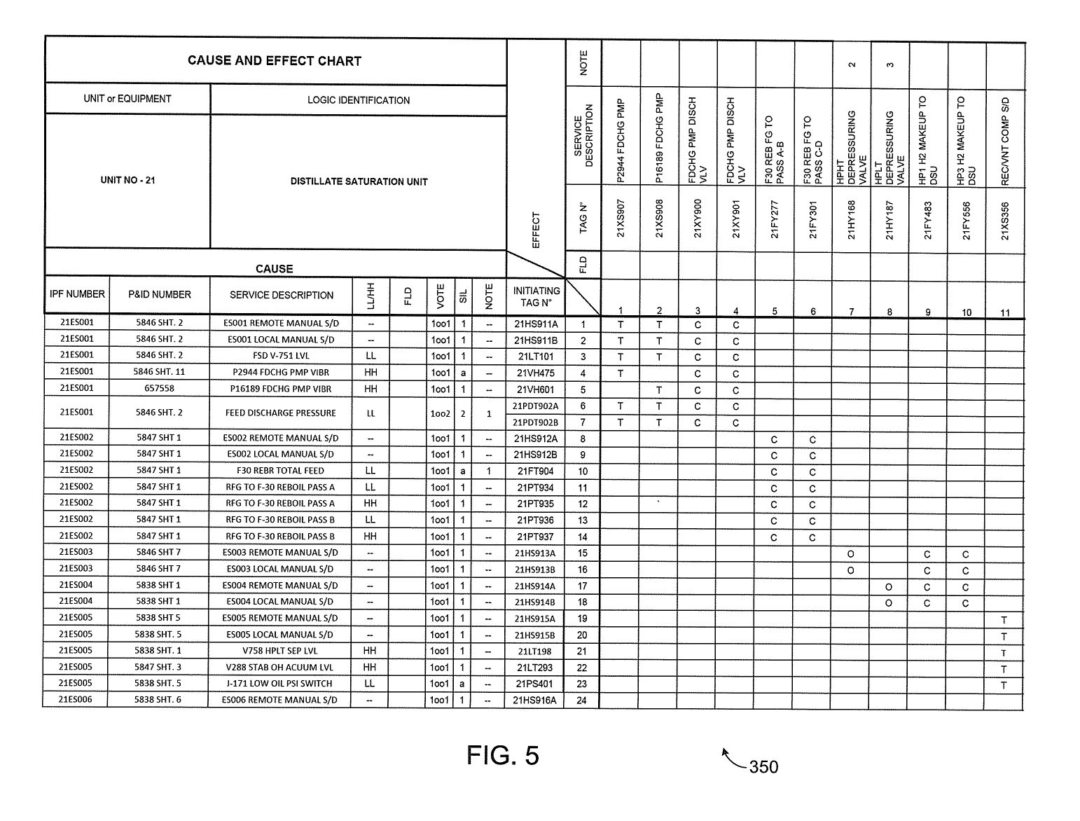

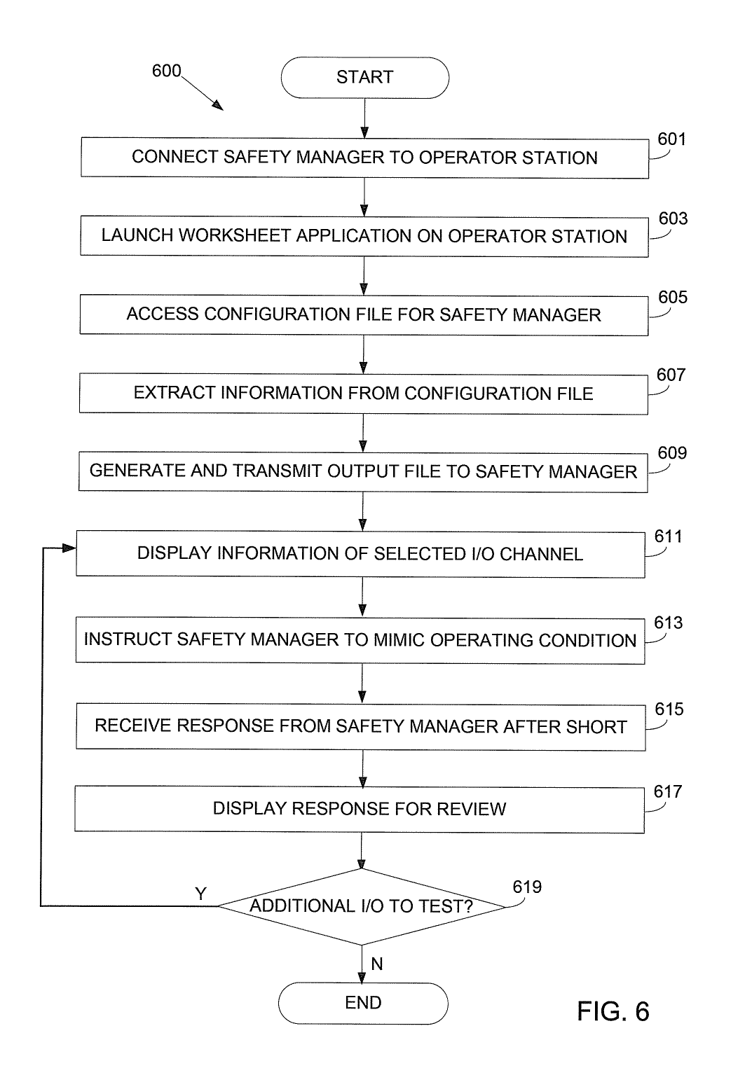

The configuration file 350 contains details and properties associated with simulating the expected or desired configuration of each I/O channel 250 in the safety manager 204. In general, the configuration file 350 is analogous to an instruction table that includes a list of inputs and outputs and is customized for an installation of a specific safety manager at a particular organization. In some embodiments, the configuration file 350 is a Cause and Effect (C&E) chart provided by an organization that uses a safety manager. For example, the C&E chart may be provided by an industrial corporation that uses a safety manager in a safety manager system as part of an industrial process and control system. FIG. 5 illustrates example portions of a configuration file 350 that is formatted as a C&E chart according to this disclosure.

The tool 330 extracts information from the configuration file 350 into the EXCEL worksheet 340. In some embodiments, the EXCEL worksheet 340 can be generated offline and in advance of testing along with other EXCEL worksheets for other tests based on other configuration files. Such advance planning can provide a one-to-one relationship of different EXCEL worksheets and different configuration files associated with different organizations and can save significant time during the actual testing of one or more safety managers.

Once the EXCEL worksheet 340 is generated, the tool 330 extracts information from the worksheet 340, the configuration file 350, or both to generate an output file 360 that is organized according to the physical layout of the I/O channels 250 of the safety manager 204. The output file 360 is transmitted to the safety manager 204 through the interface 320 and stored in a memory. The operator station 302 can also send other test instructions to the safety manager 204 through the interface 320 as described below. At this point, the safety manager 204 is in a running state and is ready for testing.

During testing of the I/O channels 250, the EXCEL worksheet 340 displays information associated with the expected physical state of the I/O channels 250 as determined from the configuration file 350. For each channel 250, based on the information in the EXCEL worksheet 340, the operator station 302 provides instructions or inputs to the safety manager 204 to have the safety manager 204 simulate a particular operating condition in association with the particular channel 250. At substantially the same time, a user manipulates the input of the channel 250 so that the condition can be tested to show the outputs performed their action as designed. In some embodiments, a first user is positioned at the operator station 302, and a second user is positioned at the back of the safety manager 204. The first user is responsible for reading and providing instructions based on the EXCEL worksheet 340, and the second user is responsible for listening to the instructions from the first user and then shorting each input of the I/O channels 250 one at a time when directed. When a channel is shorted, there is a response at the safety manager 204. The response is transmitted back to the operator station 302 through the interfaces 220, 320 and displayed on the GUI 310. The response can include a physical value and an application value. In some embodiments, the physical value is a voltage reading of the particular I/O channel 250. The values can be compared against one or more expected values in the configuration file 350. The values indicate to the users if the channel 250 is operating correctly or needs attention.

To test the logic portion of the safety manager 204, the second user positioned at the safety manager 204 is not needed. The operator station 302 simply sends instructions or inputs to the safety manager 204 and receives outputs or results from the safety manager 204, where the output is based on the logic programmed into the safety manager 204. The outputs can be displayed at the GUI 310 so that an operator can determine if the logic results are acceptable. In some embodiments, the outputs can be color-coded for easy understanding (such as red for a bad result and green for a good result).

Use of the test system 300 provides a number of benefits compared to using a conventional test panel. For example, significant time savings can be achieved in setting up and testing all inputs and outputs of the safety manager 204. The test system 300 may require minimal set up time, thereby saving valuable work-hours in testing and providing cost savings and schedule buffers for project plans. As a particular example, for many types of safety managers 204, a test that would take three days to complete using a test panel could be performed in about thirty minutes using the test system 300. The test system 300 also eliminates the need for conventional test panels and the significant ongoing time and pecuniary expenses associated with maintaining the test panels.

In addition, because the configuration file 350 can be customized to include the inputs and outputs of the safety manager 204 as it will be used for a particular organization, the testing performed using the test system 300 is also customized according to the configuration file 350. This facilitates execution of testing with a more focused attention on the organization associated with the configuration file 350 and its expected pass/fail results, as opposed to the conventional test panel method where all outputs have to be monitored on every lamp panel to check for correct test results. This results in a much more efficient execution of logic tests with results that are more obvious to interpret and an ability to quickly reset the test system 300 from the operator station 302 after every test to quickly proceed to the next test.

Although FIGS. 3 through 5 illustrate one example of a test system 300 for testing safety manager components and related details, various changes may be made to FIGS. 3 through 5. For example, the use of EXCEL spreadsheets is optional, and other suitable applications could be used. Also, testing need not include users manually causing shorts but could instead include devices (such as switches) that are controlled electronically to create shorts where desired.

FIG. 6 illustrates an example method 600 for testing a safety manager according to this disclosure. For ease of explanation, the method 600 is described as being performed by the system 300 of FIG. 3. However, the method 600 could be used with any suitable device or system.

At step 601, a safety manager is connected to an operator station. This may include the safety manager 204 being connected to the operator station 302 via the interfaces 220, 320. In some embodiments, the operator station and the safety manager are connected via a serial connection, an Ethernet connection, or both. At step 603, a worksheet-based application is launched on the operator station. The application can include a customized plug-in tool. This may include launching MICROSOFT EXCEL on the operator station 302, where the plug-in tool 330 is launched with EXCEL. At step 605, a configuration file associated with a plurality of inputs and outputs of the safety manager is accessed. At step 607, information from the configuration file is extracted into a worksheet. This may include the plug-in tool 330 accessing the configuration file 350 and extracting information into the EXCEL worksheet 340. At step 609, an output file based on the configuration file is generated and transmitted from the operator station to the safety manager. This may include the plug-in tool 330 generating the output file 360, which is then transmitted to the safety manager 204.

At step 611, an I/O channel of the safety manager is selected to be tested, and information associated with an expected state of the I/O channel is displayed. This may include the EXCEL worksheet 340 displaying information associated with the selected I/O channel 250. At step 613, the safety manager is instructed to simulate a particular operating condition in association with the I/O channel. This may include the operator station 302 providing instructions or inputs to the safety manager 204 to have the safety manager 204 simulate a particular operating condition in association with the particular channel 250.

At step 615, the I/O channel is shorted (such as automatically or by a user), and a response is received from the safety manager following the shorting. This may include a response being generated at the safety manager 204 and transmitted back to the operator station 302 through the interfaces 220, 320. The response indicates whether or not the I/O channel is operating correctly. At step 617, the response is displayed for review. This may include the response being displayed on the GUI 310.

At step 619, it is determined if there is an additional I/O channel of the safety manager to test. If there is an additional I/O channel to test, the method returns to step 611. Otherwise, the method 600 ends.

Although FIG. 6 illustrates one example of a method 600 for testing a safety manager, various changes may be made to FIG. 6. For example, while shown as a series of steps, various steps shown in FIG. 6 could overlap, occur in parallel, occur in a different order, or occur multiple times. Moreover, some steps could be combined or removed and additional steps could be added according to particular needs. Also, while the method 600 and the test system 300 are described with respect to a safety manager in a safety manager system, the method 600 and system 300 may be used in conjunction with testing of other types of devices, such as programmable logic controllers (PLCs).

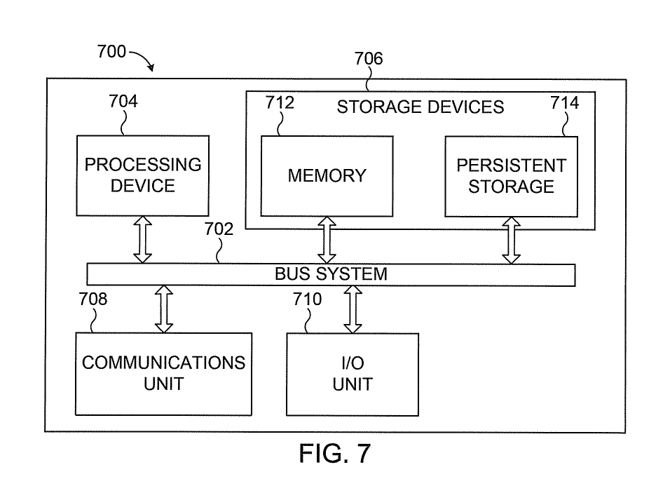

FIG. 7 illustrates an example computing device 700 for implementing the methods and teachings according to this disclosure. The device 700 could, for example, represent any of the controllers, operator stations, safety managers, and computing devices described above. Note, however, that other implementations of the controllers, operator stations, safety managers, and computing devices could also be used.

As shown in FIG. 7, the device 700 includes a bus system 702, which supports communication between at least one processing device 704, at least one storage device 706, at least one communications unit 708, and at least one input/output (I/O) unit 710. The processing device 704 executes instructions that may be loaded into a memory 712. The processing device 704 may include any suitable number(s) and type(s) of processors or other devices in any suitable arrangement. Example types of processing devices 704 include microprocessors, microcontrollers, digital signal processors, field programmable gate arrays, application specific integrated circuits, and discrete circuitry.

The memory 712 and a persistent storage 714 are examples of storage devices 706, which represent any structure(s) capable of storing and facilitating retrieval of information (such as data, program code, and/or other suitable information on a temporary or permanent basis). The memory 712 may represent a random access memory or any other suitable volatile or non-volatile storage device(s). The persistent storage 714 may contain one or more components or devices supporting longer-term storage of data, such as a ready only memory, hard drive, Flash memory, or optical disc.

The communications unit 708 supports communications with other systems or devices. For example, the communications unit 708 could include a network interface card that facilitates communications over at least one Ethernet or serial connection. The communications unit 708 could also include a wireless transceiver facilitating communications over at least one wireless network. The communications unit 708 may support communications through any suitable physical or wireless communication link(s).

The I/O unit 710 allows for input and output of data. For example, the I/O unit 710 may provide a connection for user input through a keyboard, mouse, keypad, touchscreen, or other suitable input device. The I/O unit 710 may also send output to a display, printer, or other suitable output device.

Although FIG. 7 illustrates one example of a computing device 700, various changes may be made to FIG. 7. For example, various components in FIG. 7 could be combined, further subdivided, or omitted and additional components could be added according to particular needs. Also, computing devices can come in a wide variety of configurations, and FIG. 7 does not limit this disclosure to any particular configuration of computing device.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” is refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
transmitting an output file to a safety manager, the output file based on a configuration file associated with a plurality of inputs and outputs of the safety manager; and
for each input/output (I/O) channel of the safety manager to be tested:
displaying information associated with an expected state of the I/O channel;
instructing the safety manager to simulate a particular operating condition in association with the I/O channel;
receiving a response from the safety manager when the I/O channel is shorted, the response indicating whether or not the I/O channel is operating correctly; and
displaying the response.

2. The method of claim 1, further comprising:
launching a worksheet-based application;
accessing the configuration file;
extracting information from the configuration file into a worksheet; and
generating the output file based on the configuration file.

3. The method of claim 2, wherein:
the application has a customized plug-in tool; and
the customized plug-in tool accesses the configuration file, extracts the information from the configuration file into the worksheet, and generates the output file based on the configuration file.

4. The method of claim 1, wherein the safety manager is part of a safety manager system associated with an industrial process and control system.

5. The method of claim 1, wherein the configuration file is customized for an installation of a particular safety manager at a particular organization.

6. The method of claim 5, wherein the configuration file comprises a Cause and Effect chart.

7. The method of claim 1, further comprising:
connecting a computing device to the safety manager via at least one of: a serial connection and an Ethernet connection;
wherein the computing device controls the testing of each I/O channel of the safety manager.

8. An apparatus comprising:
at least one interface configured to communicate with a safety manager; and
at least one processing device configured to:
initiate transmission of an output file to the safety manager, the output file based on a configuration file associated with a plurality of inputs and outputs of the safety manager; and
for each input/output (I/O) channel of the safety manager to be tested:
display information associated with an expected state of the I/O channel;
instruct the safety manager to simulate a particular operating condition in association with the I/O channel;
receive a response from the safety manager when the I/O channel is shorted, the response indicating whether or not the I/O channel is operating correctly; and
display the response.

9. The apparatus of claim 8, wherein the at least one processing device is configured to:
launch a worksheet-based application;
access the configuration file;
extract information from the configuration file into a worksheet; and
generate the output file based on the configuration file.

10. The apparatus of claim 9, wherein:
the application has a customized plug-in tool; and
the customized plug-in tool is configured to access the configuration file, extract the information from the configuration file into the worksheet, and generate the output file based on the configuration file.

11. The apparatus of claim 8, wherein the safety manager is part of a safety manager system associated with an industrial process and control system.

12. The apparatus of claim 8, wherein the configuration file is customized for an installation of a particular safety manager at a particular organization.

13. The apparatus of claim 12, wherein the configuration file comprises a Cause and Effect chart.

14. The apparatus of claim 8, wherein the at least one interface comprises at least one of: a serial interface and an Ethernet interface.

15. A non-transitory computer readable medium containing instructions that, when executed by at least one processing device, cause the at least one processing device to:
initiate transmission of an output file to a safety manager, the output file based on a configuration file associated with a plurality of inputs and outputs of the safety manager; and
for each input/output (I/O) channel of the safety manager to be tested:
display information associated with an expected state of the I/O channel;
instruct the safety manager to simulate a particular operating condition in association with the I/O channel;
receive a response from the safety manager when the I/O channel is shorted, the response indicating whether or not the I/O channel is operating correctly; and
display the response.

16. The non-transitory computer readable medium of claim 15, further containing instructions that, when executed by the at least one processing device, cause the at least one processing device to:
launch a worksheet-based application;
access the configuration file;
extract information from the configuration file into a worksheet; and
generate the output file based on the configuration file.

17. The non-transitory computer readable medium of claim 16, wherein:
the application has a customized plug-in tool; and
the customized plug-in tool is configured to access the configuration file, extract the information from the configuration file into the worksheet, and generate the output file based on the configuration file.

18. The non-transitory computer readable medium of claim 15, wherein the safety manager is part of a safety manager system associated with an industrial process and control system.

19. The non-transitory computer readable medium of claim 15, wherein the configuration file is customized for an installation of the safety manager at a particular organization.

20. The non-transitory computer readable medium of claim 19, wherein the configuration file comprises a Cause and Effect chart.
